(19) United States
(12) Patent Application Publication
(10) Pub. No.: US 2018/0239869 A1
(43) Pub. Date: Aug. 23, 2018

(54) SYSTEMS AND METHODS FOR DISPLAYING HEALTH METRICS IN A CALENDAR VIEW

(71) Applicant: Under Armour, Inc., Baltimore, MD (US)

(72) Inventors: Scott Laing, Austin, TX (US); David Messing, Austin, TX (US); Brian Carden, Austin, TX (US); Gwen Johnson, Austin, TX (US)

(21) Appl. No.: 15/438,234

(22) Filed: Feb. 21, 2017

(51) Int. Cl. G06F 19/00; G06Q 10/10

(52) U.S. Cl. CPC G06F 19/324; G06T 11/001; G06Q 10/1093; G06F 19/3481

(57) ABSTRACT

Systems and methods for displaying health metrics in a calendar view. In one embodiment, a method for presenting health data to a user is disclosed. In one variant the method comprises: obtaining data relating to a first health parameter and data relating to a second health parameter, individual ones of the data being associated to respective days; arranging icons representative of the days into a calendar display; applying a color other than black to the icons for which the first data was obtained, the color being saturated according to a value of the first data; and shading the icons for which the second parameter data was obtained, an amount of shading being based on a value of the second parameter data.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

The device and method disclosed in this document relates health tracking devices and, more particularly, to health tracking devices configured to display multiple health metrics in a calendar view.

### BACKGROUND

Health tracking devices are increasingly utilized by individuals interested in tracking metrics related to their personal health and fitness activity. These health tracking devices include, for example, heart rate monitors, step counters, stair counters, global positioning system (“GPS”) tracking devices, as well as various other motion and biometric tracking devices. The increased popularity and use of health trackers has created vast amounts of data coming from disparate sources over long periods of time. Because of the vast amounts of data collected over long periods of time, it is often difficult to present the data to the user in a logical easy-to-comprehend form.

Various display arrangements have been implemented in past devices which present data to the user in a summarized format. While this information may be desired by the user, it often remains difficult for the user to determine what effect certain activities have had upon his or her health and general wellbeing.

In view of the foregoing, it would be advantageous to provide a health tracking device having a display that is configured to show a concise summary of numerous activity-related parameters for a given period of time. It would also be advantageous for the display to include an intuitive presentation that allows the user to identify trends and associations between health and activity in a quick and convenient manner.

### SUMMARY

In accordance with one exemplary embodiment of the disclosure, a method of presenting health data to a user is disclosed. In one variant, the method comprises (i) obtaining a plurality of data relating to a first health parameter, individual ones of the plurality of data being associated to respective individual ones of a plurality of days; (ii) obtaining a plurality of data relating to a second health parameter, individual ones of the plurality of data being associated to respective individual ones of a plurality of days; (iii) arranging a plurality of icons representative of the plurality of days into a calendar display; (iv) applying a color other than black to the icons representative of the individual ones of the plurality of days for which the first parameter data was obtained, the color being saturated according to a value of the first parameter data relating thereto; and (v) shading the icons representative of the individual ones of the plurality of days for which the second parameter data was obtained, an amount of shading being based on a value of the second parameter data relating thereto.

Pursuant to another exemplary embodiment of the disclosure, a display device for presenting health data to a user is disclosed. In one variant, the display device comprises one or more transceivers, a storage apparatus, and a processor configured to execute at least one computer application thereon. In a further variant, the computer application comprises a plurality of instructions stored at the storage apparatus and which are configured to, when executed, cause the display device to: (i) receive at the one or more transceivers measurable health parameter data collected via one or more sensors, the measurable health parameter data being associated to one of a plurality of 24 hour time periods; (ii) receive at the one or more transceivers health perception data input by the user, the health perception data being associated to one of a plurality of 24 hour time periods; (iii) display via a display screen a plurality of icons, the plurality of icons representative of the plurality of 24 hour time periods and arranged into a calendar configuration; (iv) modulate at least one attribute of each icon based on a value of the measurable health parameter data for each of the respective 24 hour time periods; and (v) modulate a shading of each icon based on a value of the health perception data for each of the respective 24 hour time periods.

In accordance with yet another exemplary embodiment, a non-transient computer readable medium comprising instructions for controlling a display device to present health data to a user is disclosed. In one variant, the instructions are configured to cause the display device to: (i) receive a plurality of health data, individual ones of the plurality of data being associated to respective individual ones of a plurality of days, the health data comprising first subjective data and second measurable data; (ii) process the plurality of health data for presentation on a display device, the processing comprising determining a value for each of the subjective and the measurable data for individual ones of the plurality of days; (iii) display a plurality of icons in a calendar arrangement such that each icon corresponds to an individual one of a plurality of days of the month and the icons are arranged to form at least six rows of seven icons; (iv) modulate a first attribute of each icon based on the value of the subjective health data associated with the day corresponding to the respective icon; and (v) modulate a second attribute of each icon based on the value of the measurable health data associated with the day corresponding to the respective icon.

### BRIEF DESCRIPTION OF THE DRAWINGS

The foregoing aspects and other features of a health and fitness tracking system are explained in the following description, taken in connection with the accompanying drawings.

FIG. 1 is a diagrammatic view showing an exemplary embodiment of a health tracking system including a sensor device and a display device;

FIG. 2 is a block diagram of exemplary electronic components in the sensor device and the display device of the health tracking system of FIG. 1;

FIG. 3 is a plan view showing the display device of the health tracking system of FIG. 1 including a dashboard screen displayed on the display device, the screen including health data for a user obtained by the sensor device and a health perception prompt;

FIG. 4 is a plan view showing the display device of the health tracking system of FIG. 1 including a calendar view screen displayed on the display device, the screen including a plurality of icons that are modulated present health metrics for corresponding days;

FIG. 5 is illustration of an exemplary icon for the calendar view screen displayed on the display device as shown in FIG. 4; and

FIG. 6 is a logical flow diagram showing a method of presenting health data to a user.

The patent or application file contains at least one drawing executed in color. Copies of this patent or patent application publication with color drawing(s) will be provided by the Office upon request and payment of the necessary fee.

All Figures © Under Armour, Inc. 2017. All rights reserved.

### DETAILED DESCRIPTION

Disclosed embodiments include systems, devices, methods, and non-transitory computer readable mediums associated with health tracking in general, and in particular enabling display of multiple health metrics in a calendar view

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used with respect to embodiments of the present disclosure, are synonymous.

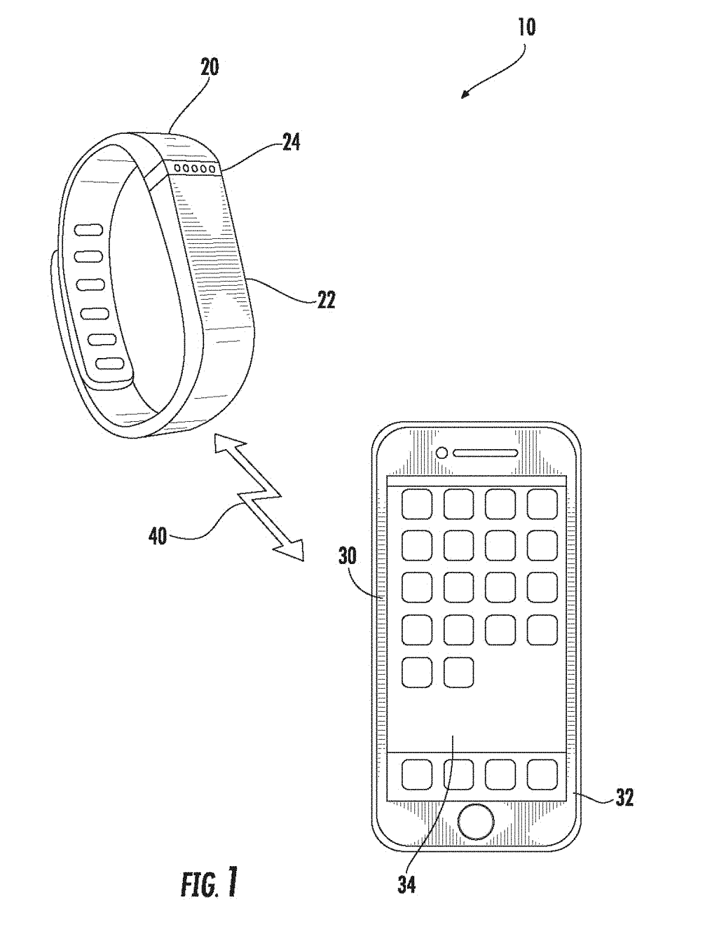

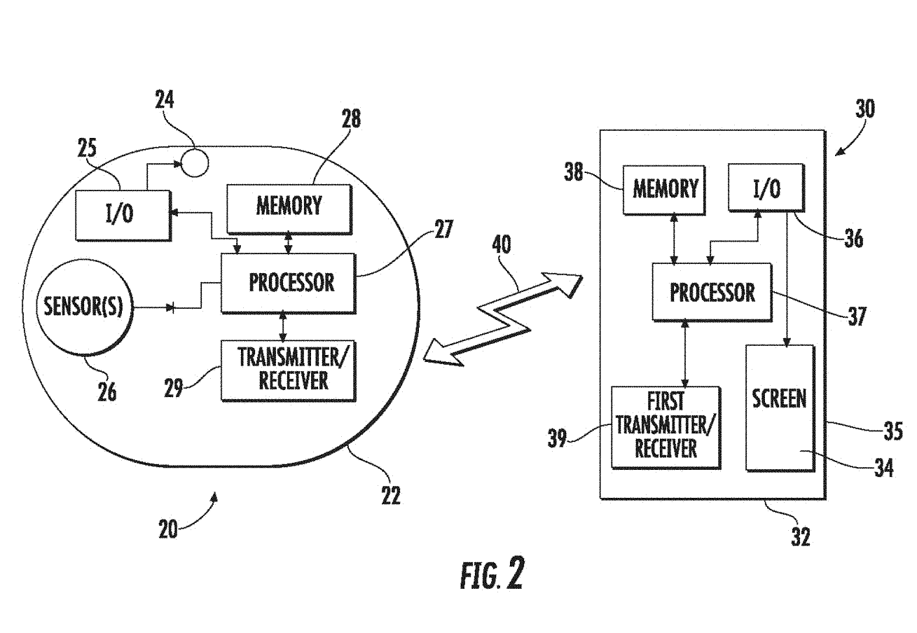

With reference to FIGS. 1-2, an exemplary embodiment of a health tracking system 10 includes at least one health monitoring device 20 and an electronic display device 30 in communication therewith. The health monitoring device 20 is, in one embodiment, designed and dimensioned to be worn on or carried by the body of a user and configured to collect activity information, physiological information, or other health information about the user. In another embodiment, the health monitoring device 20 may comprise a non-portable device configured to measure one or more health parameters of the user. For example, the device may include a scale configured to measure the user's weight. Moreover, an individual user may be associated to more than one health monitoring device 20 (as discussed in greater detail elsewhere herein). The health monitoring device 20 is in communication with the electronic display device 30, and is configured to deliver the collected data about the user to the electronic display device 30. The collected data may include activity data, physiological data, or any other type other health data. The electronic display device 30 is designed to process the health data and display it to the user in a format that shows context for daily exercise, general activity, nutritional habits, and sleep behavior.

Although not illustrated, in one embodiment, the health monitoring device 20 and electronic display device 30 may communicate via a network to a network-side database and/or server (not shown) for storage and/or processing of the health data, thereby decreasing the processing capacity required at either the health monitoring device 20 or electronic display device 30.

Health Monitoring Device

The health monitoring device 20 (which may also be referred to herein as a “health tracking device” or a “sensor device”) may be provided in any of various forms and is configured to collect any of various types of health data related to a user. The term “health data” as used herein refers to data relating to a user's health and general well-being, and may also be referred to herein as “health information” or “health parameters.” Health data may include data such as activity data, nutritional data, physiological data, and health perception data. Health data may be in a raw measured form or in a processed form. The term “activity data” as used herein is a subset of health data, and refers to data related to physical activity (i.e., movement or lack thereof) of the user. Examples of activity data include step data, body motion data, distance traversal data, altitude data, heart rate data, breathing data, environmental/positional data (such that provided by a GPS receiver), or any of various other types of personal activity metrics that may be relevant the user's physical activity for a given period of time. The term “nutritional data” as used herein is a subset of health data, and refers to data related to dietary consumption of the user. Examples of nutritional data may include dietary logs for foods and beverages consumed by the user, as well as nutritional content information such as caloric content, macronutrients, micronutrients, serving size, and other nutrition and health information for the foods and beverages consumed by the user. Nutritional data may also include logs and information regarding dietary supplements, vitamin supplements, medication, or any of various other items for consumption that may be relevant the user's dietary consumption for a given period of time. The term “physiological data” as used herein is a subset of health data, and refers to data related to the physiological status and health of the user. Examples of physiological data include age, gender, height, body weight, body fat, heart rate, aspiration rate, blood oxygenation, blood glucose, hydration, sleep patterns, caloric expenditure, or any of various other types of physiological metrics that may be relevant the user's physiological health for a given period of time. The term “health perception data” as used herein is a subset of health data, and refers to data related a personal feeling or subjective perception of one's own health as determined by the user himself or herself based on the user's own senses, feelings, awareness, mental impressions, or other perceptions of the user. Health perception data may broadly relate the user's perception of his or her overall health, but may also relate to the user's perception of particular aspects of his or her health, such as the user's perception of his or her caloric intake, weight, activity level, or any of the health parameters discussed above. Accordingly the data referred to herein may be measured, sensed, collected, and/or measured by the health monitoring device 20 and/or entered by the user.

The health monitoring device 20 may be configured to measure, collect and/or otherwise obtain any of the various types of health data discussed above. The health data may be collected via manual entry by the user, automatically by a sensor of the health monitoring device 20, and/or collected by any of various other means. In at least one embodiment, the health monitoring device 20 may be an activity tracker configured to measure one or more of steps taken (including walking or running), distance traversed, stairs climbed, heart rate, as well as various other types of activity data or physiological data (such “activity trackers” are commonly also referred to as “fitness trackers”). Additional or alternative examples of health-monitoring devices 20 include those sold under the trademarks FITBIT®, JAWBONE®, POLAR®, APPLE® and UNDER ARMOUR®.

The health monitoring device 20 may be configured to further process the measured health data to determine health metrics such as calories spent, sleep quality, etc. Such further processing may occur on the health monitoring device 20 itself or in association with other computer devices in communication with the health monitoring device 20. The term “health metric” as used herein refers to any standard of measurement relevant to an assessment of the health and general well-being of a user and can be considered a type of health data. In some cases, the raw measured health data is processed substantially to provide a health metric, but in other cases, measured health data may simply be organized into a more presentable form to provide the health metric. Some examples of health metrics include heart rate data expressed as beats per minute, a number of steps for a day, activity data expressed as a distance traversed over some time period, a number of calories spent over some time period, a number of calories consumed for a day, a total duration of activity, a body weight, an amount of body fat, and sleep quality defined by sleep time and/or sleep quality/sleep cycles. Further exemplary health metrics may include any parameter of the health data expressed as a number or as a percentage of some goal or other standard.

In one exemplary embodiment the health monitoring device 20 is configured to be worn or carried by the human user. For example, in the embodiment shown in FIG. 1, the health monitoring device 20 is provided as a wrist band that the user straps to his or her wrist. However, it will be recognized that in other embodiments, the health monitoring device 20 may be provided in any of various different configurations to be worn on any of various locations on the body of the user, such as via a module that clips on to clothing, is worn on a chest strap, fits in a pocket of the user, and/or is incorporated into a garment or a shoe. Alternatively, the health monitoring device 20 may be fixed and non-portable device (i.e., not worn by the user), such as for example, a so-called smart scale onto which a user stands and/or a tablet or personal computing device into which the user enters health data, such as nutritional data. Additional examples of configurations for the health monitoring device 20 include configurations where the sensor device is provided as a component of a multi-function device, such as a watch, a mobile phone or other personal electronic device. In the embodiment disclosed herein, the health monitoring device 20 is shown as being a completely separate unit from the display device 30. However, in at least one embodiment, the health monitoring device 20 and the display device 30 are provided as a single unit. For example, the health monitoring device 20 and the display device 30 may be provided as part of a mobile phone, so-called “smart” watch or other personal electronic device. While a single health monitoring device 20 is shown in the embodiment of FIG. 1, it will be recognized that multiple sensor devices may be used by a single user, each of the health monitoring device 20 configured for communication with the electronic display device 30.

With continued reference to the embodiment of FIGS. 1 and 2, the health monitoring device 20 includes a protective outer shell or housing 22 designed to retain and protect various sensors and other electronic components positioned within the housing 22. The housing 22 comprise any number of shapes, configurations, and/or materials, the description herein being merely exemplary. In at least one embodiment, the housing 22 includes a relatively rigid portion that securely retains the electronic components, and a more resilient portion which functions as an outer layer to provide shock absorption features in the event the health monitoring device 20 is dropped, falls, or otherwise withstands an amount of force. The health monitoring device 20 and housing 22 may be configured to be worn or otherwise carried by the user in any of a number of ways. For example, the housing 22 of the health monitoring device 20 may be provided as part of a chest or wrist strap having an associated clasp, or may include a clip or other arrangement that allows the health monitoring device 20 to be coupled to the clothing of the user (as discussed elsewhere herein).

The health monitoring device 20 may also include other features visible on the housing 22 such as an I/O interface 25, which may include a display 24, one or more connection ports (not shown), or other input and output hardware and software. The display 24 may vary based on the type of device. For example, in one embodiment the display 24 may simply be one or more colored lights and/or flashing patterns configured to communicate information to the user (e.g., progress towards a goal or other health metric). In another embodiment, the display 24 may be an LCD or LED screen that provides more specific health metric information to the user (e.g., total number of steps for the day, progress towards a goal, heart rate, some combination thereof, etc.). The connection ports may be used to connect the health monitoring device 20 to a power source or to share data with other electronic devices.

As shown in FIG. 2, the health monitoring device 20 includes electronic circuitry comprising one or more sensors 26 (optional), a processor 27, a memory 28, and a transmitter/receiver 29 (which may also be referred to herein as “transceiver”). The health monitoring device 20 also includes a battery or other power source (not shown) configured to power the various electronic devices within the health monitoring device 20. In at least one embodiment, the battery of the health monitoring device 20 is a rechargeable battery. In this embodiment, the health monitoring device 20 may be placed in or connected to a battery charger configured for use with the sensor module in order to recharge the battery.

In one embodiment, the health monitoring device 20 comprises one or more sensors 26. The sensors 26 may comprise any of various devices configured to collect the activity or physiological data, including step data, motion data, distance traversal data, GPS data, body weight data, altitude data, heart rate data, body temperature data, breathing data, environmental/positional data, or any of various other types of health metrics that may be relevant to determining activities of the wearer. In at least one embodiment, the sensor is a 3-axis accelerometer configured to detect the steps of the wearer during walking and running, and general movements of the wearer during more sedentary periods such as sleep. Of course, it will be recognized by those of ordinary skill in the art that numerous other sensors may be used, depending on the type of activity the health monitoring device 20 is designed to detect.

With continued reference to FIG. 2, the processor 27 may be any of various microprocessors as will be recognized by those of ordinary skill in the art. The processor 27 is configured to receive data signals from the sensors 26, and other component parts of the health monitoring device 20 (such as data entered via the I/O input), and process such signals. The processor 27 is connected to the memory 28 and the transceiver 29, and may deliver processed data to one or both of the memory 28 and the transceiver 29. Additionally, the processor 27 may perform some processing on the received data prior to delivery thereof to the memory 28 or transceiver 29. For example, the processor 27 may associate the data with a particular time, day, user (in the instance that the device is configured to collect data relating to more than one user), and/or event. The processor 27 is also connected to the I/O interface 25, and may send signals to the I/O interface 25 which results in illumination of the display 24 in order to provide text and/or image based messages or otherwise communicate to the user.

The memory 28 is configured to store information, including both data and instructions. The data may be retrieved from the processor 27 and generally includes health data, but may also include various types of operational data that may be ancillary to the basic operation of the health monitoring device 20. The instructions which are stored at the memory 28 generally include firmware and/or software for execution by the processor 27, such as a program that controls the settings for the sensor device, a program that controls the output of the display 24 on the health monitoring device 20, a program that controls the receipt of information via the sensor 26, a program that controls the transmission and reception of data via the transceiver 29, as well as any of various other programs that may be associated with the health monitoring device 20. Such instructions may be present on the device 20 at the time of manufacture or may be downloaded thereto via well-known mechanisms.

The memory 28 may be of any type capable of storing information accessible by the processor 27, such as a memory card, ROM, RAM, write-capable, read-only memories, or other computer-readable medium. The data may be stored in the memory 28 in a relational database as a table having a plurality of different fields and records, XML documents, or flat files. The data may also be formatted in any computer-readable format such as, but not limited to, binary values, ASCII or Unicode.

The transceiver 29 in one embodiment comprises an RF transmitter and receiver configured to transmit and receive communications signals over a short range using a wireless communications technology, such as Bluetooth®, using any of various communications protocols, such as TCP/IP. Such transceivers are well known and will be recognized by those of ordinary skill in the art. The transceiver 29 is particularly configured to communicate with the display device 30 when the health monitoring device 20 is within a given range of the display device 30, and transmit collected health data to the display device 30.

While the health monitoring device 20 has been described herein as the primary device for collecting and transmitting health data to the display device 30, it will be recognized that additional data may also be collected or otherwise obtained and/or input in to the display device 30 via various other mechanisms. In at least one embodiment, the user may manually input data directly into the health monitoring device 20 and/or the display device 30. For example, the user may manually collect sleep data or calorie consumption data and input such data into the health monitoring device 20 and/or the display device 30 without the use of a sensor and/or other device transmitting the health data to the display device.

Display Device

With continued reference to FIGS. 1 and 2, in at least one embodiment, the display device 30 is a handheld computing device, such as a smartphone. The display device 30 generally includes an input/output interface 36, a processor 37, a memory 38, and a transceiver 39. While a smartphone has been shown as the display device 30 in FIGS. 1 and 2, it will be appreciated that the display device 30 may alternatively comprise any number of devices. For example, the display device 30 may be a standalone device, such as a desktop PC or smart television. Alternatively, the display device may be any type of portable or other personal electronic device such as a watch, tablet computer, laptop computer, or any of various other mobile computing devices. As will be recognized by those of ordinary skill in the art, the components of the display device 30 may vary depending on the type of display device used. Such alternative display devices may include much (but not necessarily all) of the same functionality and components as the display device 30 shown in FIGS. 1 and 2, as well as additional functionality or components necessary for proper functioning thereof (not shown). In addition, the display device 30 may function as one of the one or more health monitoring devices 20 discussed elsewhere herein.

The display device 30 includes a protective outer shell or housing 32 designed to retain and protect the electronic components positioned within the housing 32. The housing 32 may comprise any number of shapes, configurations, and/or materials, the description herein being merely exemplary. In at least one embodiment, the housing 32 includes a relatively rigid portion that securely retains the electronic components, and a more resilient portion which functions as an outer layer to provide shock absorption features in the event the device 30 is dropped, falls, or otherwise withstands an amount of force. In embodiments wherein the display device 30 also functions as one or more health monitoring devices 20, the housing 32 may serve as a common housing for components of the display device 30 and components of the health monitoring device 20.

With continued reference to FIG. 2, the I/O interface 36 of the display device 30 includes software and hardware configured to facilitate communications with the one or more health monitoring devices 20 and/or communications to the user him/herself. The hardware includes a display screen 34 configured to visually display graphics, text and other data to the user. In particular, the display screen 34 of the I/O interface 36 is configured to display health data received from the health monitoring device 20. The hardware may also include a microphone and/or speakers to facilitate audio communications with the user and/or verbal entry of commands to the device 30. In at least one embodiment, the display screen 34 is a touch screen display that allows the user to see data presented on the display screen 34 and input data into the display device 30 via a keyboard on the touch screen.

It will be recognized that the health monitoring device 20 and the display device 30 may be provided as part of a health tracking system 10, the components of which are configured to communicate via e.g., a mobile telephony network, the Internet, and/or a global positioning system (GPS). In another embodiment, the methods, apparatus and systems disclosed in co-owned, co-pending U.S. patent application Ser. No. 14/853,221, filed on Sep. 14, 2015 and entitled “ACTIVITY TRACKING ARRANGEMENT AND ASSOCIATED DISPLAY WITH GOAL-BASED DASHBOARD”, the entire contents of which are incorporated herein by reference, are utilized to perform at least certain ones of the herein discussed functionality.

The processor 37 of the display device 30 may be any of various processors as will be recognized by those of ordinary skill in the art. The processor 37 is connected to the I/O interface 36, the memory 38, and the transceiver 39, and is configured to deliver data to and/or receive data from each of these components. In at least one embodiment, the processor 37 is configured to process raw health data received from the one or more health monitoring devices 20 and transform the data into a graphical format for presentation on the display screen 34. It will be recognized by those of ordinary skill in the art that a “processor” as used herein includes any hardware system, hardware mechanism or hardware component that processes data, signals or other information. A processor can include a system with a central processing unit, multiple processing units, dedicated circuitry for achieving functionality, or other systems.

The memory 38 is configured to store information, including both data and instructions. The data may be, for example, health data as discussed above, which may be related to the activities, nutrition, sleep, environment, etc. of the user, along with other operational data that may be ancillary to the basic operation of the display device and any applications retained on the display device. The instructions which are stored at the memory 38 generally include firmware and other software for execution by the processor 37, such as a program that controls the settings for the display device, a program that controls the output of the display 34 on the display device 30, programs that control various applications on the display device, a program that controls the transmission and reception of data via the transceiver 39, as well as any of various other programs that may be associated with the display device 30. As explained in further detail below, the instructions stored in the memory 38 for execution by the processor may include, for example, an activity or health tracking app and/or a health perception tool.

The memory 38 may be of any type of device capable of storing information accessible by the processor, such as a memory card, ROM, RAM, write-capable memories, read-only memories, hard drives, discs, flash memory, or any of various other computer-readable medium serving as data storage devices as will be recognized by those of ordinary skill in the art.

In at least one embodiment, portions of the system and methods described herein may be implemented in suitable software code that may reside within the memory. Such software code may be present on the device 30 at the time of manufacture or may be downloaded thereto via well-known mechanisms. A computer program product implementing an embodiment disclosed herein may therefore comprise one or more computer-readable storage media storing computer instructions translatable by a processor to provide an embodiment of a system or perform an embodiment of a method disclosed herein. Computer instructions may be provided by lines of code in any of various languages as will be recognized by those of ordinary skill in the art. A “computer-readable medium” may be any type of data storage medium that can store computer instructions, including, but not limited to the memory devices discussed above.

The transceiver 39 is an RF transmitter and receiver configured to transmit and receive communications signals over a short range using a wireless communications technology, such as Bluetooth®, using any of various communications protocols, such as TCP/IP. Such transceivers are well known and will be recognized by those of ordinary skill in the art. The transceiver 39 is particularly configured to communicate with the transceiver 29 of the health monitoring device 20. The display device 30 also includes a battery or other power source (not shown) configured to power the transceiver 39 and various other the electronic components within the display device 30. In at least one embodiment, the transceiver 39 is configured to allow the display device 30 to communicate with a wireless telephony network, as will be recognized by those of ordinary skill in the art. The wireless telephony network may comprise any of several known or future network types. For example, the wireless telephony network may comprise commonly used cellular phone networks using CDMA or FDMA communications schemes. Some other examples of currently known wireless telephony networks include Wi-Fi, WiMax, GSM networks, as well as various other current or future wireless telecommunications arrangements.

Raw health data collected by the health monitoring device 20 may be processed by the display device 30 and/or delivered to a remote server for further processing. The processing to be performed may depend on various factors including the type of data received and different subscriptions of the user/athlete. Examples of such processing are provided in the paragraphs below.

Typical processing may relate to the user's current activity level, trends, history, training state, etc. For example, in one embodiment the one or more computers that processes the raw data may calculate an activity level which may be based on a combination of inputs, including, for example, steps taken over a period of time, heart rate, etc. In another embodiment, GPS data is used to determine various athletic data points, such as the speed of the athlete calculated over different time periods, total distance travelled, or the route taken by the athlete during a sporting event. Furthermore, the health data may be processed into different forms and formats, depending on the particular device that will ultimately be used to view the data. For example, the data may be processed into a first format that will allow it to be viewed on e.g., a smart watch and into a second format that will allow it to be viewed on the monitor of a personal computer; that is a compressed or summarized format for the smaller display and a more detailed format for the larger and more powerful display. Processing of health data may also depend on a subscription level the user maintains with the administrator of the health tracking system. If the user has a standard subscription with the administrator of the health tracking system 10, only limited processing may occur, such as an average heart rate for a period of time or a total number of steps for a day. However, if the user has a a higher subscription level with the administrator of the health tracking system, the processing of heart rate data may further include an analysis of the time the user spent in different heart rate zones during a given period of time, such as times in the fat burning zone, the aerobic zone, and the anaerobic zone. With respect to step data, users with a higher subscription level than other users may receive access to detailed information about cadence, split times, or other in-depth analysis performed by the processor (which is not available to users with standard subscription levels). While these are but a few examples of how the raw data may be processed by one or more computers of the health tracking system including the display device 30 or any remote servers, those of skill in the art will recognize that nearly countless other possibilities exist for systems and methods to process the data received from the one or more health monitoring devices 20 for subsequent viewing and analysis. After the raw activity data is transmitted and processed, the processed data may then be displayed or otherwise presented on a user interface of the display device 30.

In the instance a user carries one or more health monitoring devices 20, health data from each device 20 is delivered to the display device 30. As represented by the arrow 40 in FIGS. 1 and 2, the one or more health monitoring devices 20 are configured to transmit a wireless RF signal representative of the health data collected or obtained thereat to at least one display device 30. In addition, the health data may also be transmitted to additional computing devices (display devices 30), such as a watch or a laptop computer where the health data may be conveniently displayed for the user. In other embodiments, a wired connection may be utilized for communication of health data between the display device 30 and the health monitoring device 20. Similar logic applies to the transmission of health data to a network server (not shown).

In another embodiment, the transmission of data from the health monitoring device 20 to the display device 30 (or to a network server (not shown)) occurs automatically without the user needing to prompt the transmission. Because the transmissions in this embodiment are automatic, some mechanism may be used to turn on the transceiver 29 of the health monitoring device 20 or otherwise indicate that automatic transmissions should begin. For example, in one embodiment, an on/off switch is provided on the health monitoring device 20 that allows the athlete or user to begin automatic transmissions of data from the health monitoring device 20. In another embodiment, the health monitoring device 20 may be configured to begin transmissions once it receives a confirmation that the display device 30 is within an appropriate range of the health monitoring device 20. In yet another embodiment, data transmission may occur periodically at predetermined intervals of time. In other embodiments, where communications between the health monitoring device 20 and the display device 30 are made with a wired connection, communications only occur when the wired connection is established between the health monitoring device 20 and the display device 30.

The health data transmitted to the display device 30 is processed to determine one or more health metrics for the user. As noted above, any of various health metrics may be presented depending on the specific type of health data collected by the health monitoring device 20. For example, the health metrics may include, heart rates, awake times, sleep times, total steps, intensity level, sleep quality, calories spent, weight, body fat percentage, etc. The health metrics may provide instantaneous activity information (e.g., current heart rate) or activity information determined over a given period of time (e.g., average heart rate). If the activity data indicates that the user is walking or running, the appropriate processor 27 or 37 may determine that the user is participating in a high intensity awake activity and/or may calculate a value for the intensity level. On the other hand, if the activity data indicates that the user is sitting or generally sedentary, the appropriate processor 27 or 37 may determine that the user is participating in a lower level awake activity. In at least one embodiment, the activity data may indicate that the user is sleeping or has retired to bed for an evening. In another embodiment, the user may indicate on the health monitoring device 20 and/or on the display device 30 that he or she has retired to bed (e.g., by making an appropriate selection on the device 20 or 30). During these times, the appropriate processor 27 or 37 may determine a quality of sleep of the user by determining activity levels during sleep. Relatively low movement and/or low heart rate during sleep may indicate deeper sleep levels and significant movement during sleep and/or increased heart rate may indicate lighter sleep or even additional awake times. When the user awakens the following morning, the appropriate processor 27 or 37 may automatically determine based on the activity signals that the user has awakened from his or her sleep and is participating in activities of various intensities.

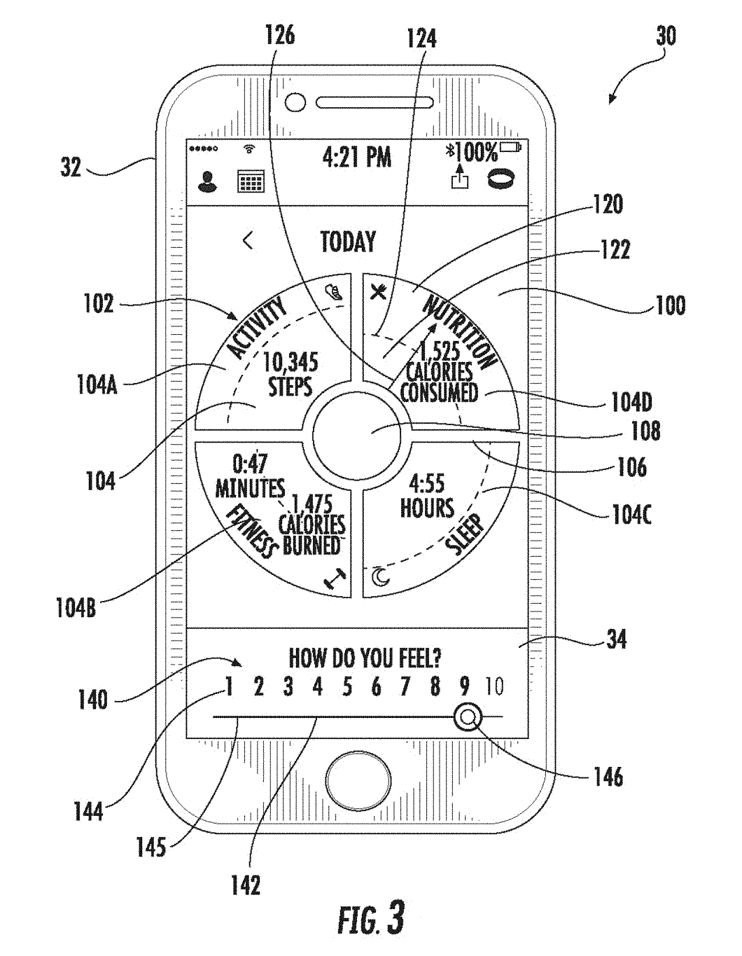

After the activity data or other health data is processed to determine one or more health metrics for the user, the processor 37 may further process the health data in order to present the health data in a format for quickly and easily communicating the collected health data to the user. To this end, the processor is configured to communicate with the I/O interface 36 and cause display of the processed activity or health information on the screen 34 for viewing by the user. One exemplary format in which the health metrics are presented to the user via the display are described in further detail below with reference to FIG. 3.

Display of Goal-Based Health Data in Sector Form

With reference now to FIG. 3, a display device 30 is shown in the form of a mobile telephone. The display device 30 includes a screen 34 configured to display the processed health data obtained from the health monitoring device 20 and/or input manually by the user. The health data on the screen 34 is, in one embodiment, processed and displayed using an activity tracking software application or “app” stored in a computer readable medium such as the memory 38 of the display device 30. The processor 37 of the display device is configured to process the instructions for the app, which may be downloaded thereto such as via a so-called “app store” or application store, and provide a graphical user interface, including various screens disclosed herein with reference to FIG. 3.

FIG. 3 shows a dashboard screen 100 of the activity or health tracking app. The dashboard screen 100 provides the user with a brief overview of health data for a period of time, such as a day. The dashboard screen 100 also serves as an entry point for the user to obtain more detailed information concerning various health data provided on the dashboard screen. In the embodiment disclosed herein, the dashboard screen 100 serves as the home screen for the activity or health tracking app, in other words, when the user first logs in to the app or opens the app, the dashboard screen 100 is displayed.

As shown in FIG. 3, the dashboard screen 100 includes a chart 102 in the form of a wheel divided into a plurality of sectors 104, including sectors 104A-104D. The sectors 104 in the embodiment of FIG. 3 are circular sectors, each sector provided as a quadrant of the wheel. Each sector 104 is positioned between two adjacent sectors (e.g., sector 104B is positioned between adjacent sector 104A and 104C). Linear gaps divide each of the adjacent sectors 104. A central hub 108 is provided at the center of the chart 102, and each of the linear gaps 106 extends radially away from the central hub 108. The central hub 108 may display data related to the user or a link to such data, including e.g., the user's weight, heart rate, profile data, or other data related to or of interest to the user.

Each sector 104 of the wheel is associated with an activity or health parameter and displays a health metric 130 for the user. In the embodiment of FIG. 3, sector 104A is associated with steps for the day, sector 104B is associated with active minutes (e.g., time participating in fitness activities) as well as the associated calories burned for the day, sector 104C is associated with sleep time for the day, and sector 104D is associated with calories consumed for the day. The activity or health parameter associated with each sector 104 may be displayed in one or more ways. For example, the “steps” activity parameter in sector 104A is represented with both text (i.e., “steps”) and an icon (i.e., the shoe icon). In at least one embodiment, each of the different sectors 104 is represented on the chart by a different color to further illustrate that each sector is associated with a different activity or health parameter (e.g., sector 104A may be a different color from each of sectors 104B, 104C and 104D).

As noted above, a health metric 130 is also displayed in association with each sector 104. In the embodiment of FIG. 3, the user's health metric 130 for sector 104A is “10,345” steps, the user's health metric for sector 104B is “0:47” active minutes (i.e., forty-seven active minutes) and 1,475 calories burned, the user's health metric for sector 104C is “4:55” hours of sleep (i.e., four hours and fifty-five minutes of sleep), and the user's health metric for sector 104D is “1,525” calories consumed.

In addition to expressing the health metric 130 for each sector 104 in raw numerical form, the health metric for each sector may also (or alternatively) be expressed in other forms. For example, the health metric may be expressed numerically or graphically as a progress toward a goal (which goal may be defined in different ways, such as a desire to exceed some value for a particular activity or health parameter or fall short of some value for another activity or health parameter). This progress may be shown in different ways, such as numerically as a fraction or a percentage of the goal. Alternatively, this progress may be shown graphically.

In the embodiment of FIG. 3, the health metric is expressed graphically as progress toward a goal. For example, as can be seen with reference to sector 104D of FIG. 3, the sector 104D is split into a first section 120 and a second section 122. The first section 120 has a first color, and the second section 122 has a second color that is different from the first color (e.g., the first section 120 may be white while the second section 122 may have a significant gray tint). Alternatively, the first section 120 and the second section 122 may be the same hue but with different lightness or color saturation (e.g. the first section 120 may be have a lower color saturation and the second section 122 may have a higher color saturation, or visa versa). A boundary 124 exists between the first section 120 and the second section 122. This boundary 124 may be provided by a defined line or may simply be represented by the color transition between the first section 120 and the second section. The entire sector 104D represents the user's goal for the health parameter for the day (e.g., consume less than 3,000 calories). The area of the first section 120 represents the user's progress toward the user's goal for the day. The numerical value “1,525” in the sector 104D displays the health metric toward that goal at the time. The area in the second section 122 represents what remains for the user to achieve the goal. In this case, if the user's goal is to consume less than 3,000 calories for the day, the user's progress is 1,525 calories consumed, which is about half of the way to the goal. Accordingly, the first section 120 extends outwardly from the central hub 108 about ½ of the distance to the outer perimeter edge of the sector. Alternatively, the first section 120 may be shown as filling about half of the total area of the sector 104D. Similar logic applies to the other ones of the user's goals displayed on the dashboard 100. As more data is collected, the user's progress toward his/her goal is dynamically updated on the dashboard 100.

With continued reference to sector 104D of FIG. 3, as additional calories are consumed by the user, the area of the first section 120 is increased, and the area of the second section 122 is decreased. In other words, for each additional calorie consumption logged by the user, the boundary 124 between the first section 120 and the second section 122 moves radially outward from the central hub 108 in the direction of arrow 126, indicating progress toward a goal. In this manner, the sectors 104 of the chart 102 provide health metrics as not only raw numerical data but also graphically as progress toward a goal. While progress toward a goal has been described in FIG. 3 by the boundary 124 moving in the direction of arrow 126, it will be appreciated that the boundary may also move in a different manner, such as toward the central hub 108. As another example, the boundary 124 may be radially-oriented and may move in a circumferential direction (instead of a circumferential boundary moving in a radial direction as shown in FIG. 3). As another example, movement toward a goal may simply be expressed in each sector as a percentage (e.g., “½ to goal” shows progress of about half the way to the stated goal).

While sector 104D shows an example of a goal where the user wishes to fall short of some measurement for an activity or health parameter, it will be recognized that in other sectors, the user's goal may be to surpass a measurement for the activity or health parameter. For example, sector in 104A, the user's goal may be to surpass 14,000 steps for the day, and the user has logged over ⅔ of the steps necessary to achieving that goal. As another example, in sector 104B, the user's goal may be two hours of physical activity for the day, and the user has yet to log half the time required to achieve that goal. As yet another example, in sector 104C, the user's goal for the day may have been to obtain seven and a half hours of sleep, and the user achieved that goal overnight. Because the user achieved the goal illustrated in sector 104C, the sector is completely one color (i.e., white), indicating that the goal has been achieved. However, as noted previously, in other embodiments the progress toward a goal may be stated differently, such as a percentage toward completing a goal (e.g., “100% of goal achieved”).

In another embodiment, when the user exceeds a goal, a new goal may be provided for the user which is an incremental increase over previous goals. In a further example, additional badges, colors, messages, animations, etc. may be provided when a user exceeds a goal.

As described above, the health data obtained by the health monitoring device 20 for the user is provided in sector form on the dashboard screen 100. In particular, the dashboard screen 100 includes a chart 102 that is divided into a number of sectors 104, each of the sectors 104 representing an activity parameter. While the chart 102 is a circular or pie-chart in the embodiment of FIG. 3, it will be recognized that the chart may be provided in other forms. For example, the chart may be provided as a square chart, oval chart, rectangular chart, or in any of various other shapes with any of various sizes. Similarly, while the sectors 104 in the embodiment of FIG. 3 are shown as circular sectors, it will be recognized that the sectors 104 may be provided in different forms. For example, the sectors may be provided on a square chart and the quadrants may be defined by triangular shapes, square shapes. Additionally, while the sectors are disclosed in the embodiment of FIG. 3 as being quadrants, it will be recognized that the sectors may also be different portions of the associated chart. For example, the sectors may define sextants or octants within the chart. Accordingly, it will be recognized that FIG. 3 shows but one exemplary representation of health data provided in sector form, and numerous variations of the display of health data in sector form are possible and contemplated herein.

Health Perception Prompt

With continued reference to FIG. 3, the lower portion of the screen 34 below the chart 102 includes a health perception prompt 140 configured to receive health perception data input by the user. The health perception prompt 140 of the dashboard includes a sliding scale 142 with a series of numbers 144 positioned along a bar 145, and a marker 146 on the bar 145, the series of numbers providing a range of values for the user. The sliding scale 142 allows the user to touch a marker 146 on the screen 34 (and/or slide the marker) and move the marker between a low number (e.g., “1”) indicating that the user does not feel well, and a high number (e.g., “10”) indicating that the user feels very well. It is further noted that other rating scheme may be utilized with equal success, such as those including a different numerical scale, icons representative of the perceived feeling, etc. The health perception prompt 140 is configured to be a subjective indication of how the user feels on a particular day. Accordingly, different users may view the health perception prompt differently. For example, some user will base entries at the health perception prompt based only on physical wellness, while others may base entries at the health perception prompt on physical and psychological wellness. Also, because pain, wellness and related scoring evaluation are subjective in nature, one user's seven rating may be another user's three. Therefore, it will be appreciated that the entries at the health perception prompt 140 are as perceived by an individual user, not by a third party. The term “health perception” as used herein refers to a personal feeling or subjective perception of one's own health as determined by the user himself or herself based on the user's own senses, feelings, awareness, mental impressions, or other perceptions of the user. As used herein, a subjective “health perception” is in contrast to a “health diagnosis” that is a more objective analysis of the health condition of the user based on the identification of symptoms of the user, physical or mental examinations of the user, analysis of biological, physical or mental tests on the user, and/or any conclusions resulting therefrom. Similarly, the term “health perception metric” as used herein refers to is type of health metric any of various standard of measurement of health perception (e.g., in the embodiment of FIG. 3, a value between one and ten, which may also be referred to herein as a “health perception score”).

In one embodiment, after a user has provided a health perception score, a color saturation of a background portion (i.e. the areas around the chart 102) of the dashboard screen 100 may be adjusted depending on the health perception score. Particularly, in response to the user providing a relatively low health perception score, the background portion is displayed with a desaturated appearance. Similarly, in response to the user providing a relatively high health perception score, the background portion is display with a saturated appearance.

In at least one embodiment, the user may move the health perception prompt any number of times during the day, but only a single entry will be saved in association with each day. For example, the health tracking app may only save the first or the final entry at the health perception prompt 140 for any given day. In another embodiment, the user may move the health perception prompt several times during the day, and multiple entries will be saved for the day, depending on any of a number of different events or triggers. For example, the health tracking app may save a first and a final entry, the entry closest to one or more times (e.g., 8:00 am, noon, 8:00 pm, etc.), the first entry immediately after a workout, etc. Alternatively, if multiple entries are entered for a day, the health tracking app may save an average of such entries, or some limited number of entries for the day.

In some embodiments, the health perception prompt 140 may include a user notes option (not shown). By touching the user notes option, the user is presented with a notes box (not shown). The user may then enter text in the notes box (e.g., by typing or speaking) which will allow the user to note why he or she is feeling a certain way. For example, if the user indicates a relatively high score for feeling on the health perception prompt 140, the user may indicate why he or she feels this way. These reasons may or may not be health related, and may be reviewed at a future time to assist the user in determining why he or she felt a certain way on a particular day (e.g., “just ran five miles,” “lots of energy after a salad with grilled chicken for lunch,” or “just had a great conversation with mom”).

In at least one embodiment, when the user slides the marker 146 below a threshold (e.g., any number below “5”) detail boxes (not shown) appear, providing the user with specific options to explain his or her feelings. The detail boxes are each associated with a perceived physiological condition related to health, wellness or feelings (e.g., tired, headache, stomach, allergies, muscle soreness, stress, lazy feeling, hung-over, etc.). The detail boxes are toggle boxes allowing the user to touch the box and mark that the condition is perceived by the user as a factor in his or her overall health at the time. In at least one embodiment, the detail boxes change depending on the number selected by the user on the sliding scale 142. For example, if a number below five is chosen, the detail boxes associated with bad feelings and poor health may be displayed; if a number of five or greater is chosen, the displayed detail boxes may be associated with different physiological conditions that may be perceived by the user (e.g., energetic, happy, rested, relaxed, strong, etc.). In at least one embodiment, the detail boxes associated with a perceived physiological condition are different depending on the number selected, however some of the detail boxes may be associated with more than one number (e.g., the “tired” detail box may be associated with each of numbers 1-5, and the “relaxed” detail box may be associated with each of numbers 5-10).

In other embodiments, additional questions may be presented to the user depending on the detail box checked by the user (e.g., “how sore are you”, “how stressed are you”, “how much energy do you have”), and each of these questions may be associated with a sliding scale. The entries for these perceived feelings may be processed as part of the data analytics to arrive at the health perception metrics (e.g., feeling very sore may not be weighed as heavily as feeling lethargic). Moreover, it will be recognized that the while the embodiment of the health perception prompt 140 disclosed herein allows the user to input health perception data using the sliding scale 142, in other embodiments health perception data may be input by the user in different manners and in different forms. Furthermore, even if the health perception prompt includes a scale, the scale may be arranged differently than that shown in FIG. 3. Accordingly, while one embodiment of the health perception prompt 140 of the dashboard screen 100 is shown and described herein, it will be appreciated that various embodiments of the health perception prompt 140 and methods for entry of related health perception data are possible.

Calendar View for Health Metrics

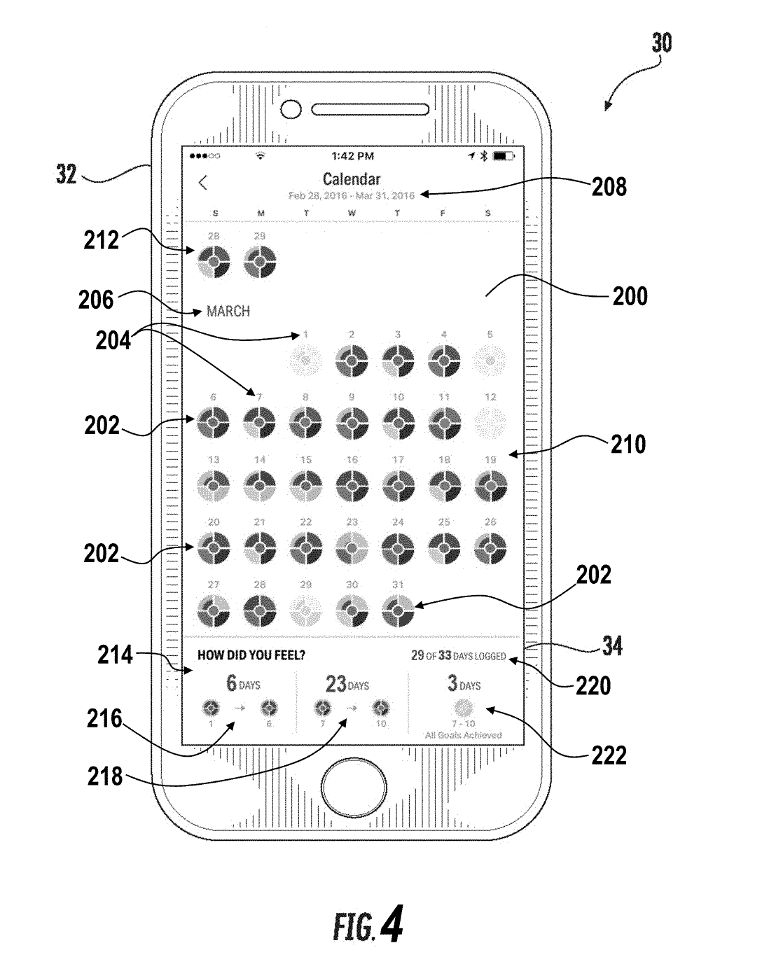

With reference now to FIG. 4, a calendar view for health metrics (which may also be simply referred to herein as a “calendar view”) is shown. The calendar view provides the user with a convenient means for determining whether particular activities result in or associated with particular feelings or perceptions. The calendar view is stored as instructions in the memory 38 of the display device 30 and is configured for execution by the processor 37. Such instructions may be present on the display device 30 at the time of manufacture or may be downloaded thereto via well-known mechanisms. The calendar view may be part of the activity or health tracking app, or may comprise a separate app used in association therewith; instructions for performing the herein disclosed functionality may be stored in the memory 38 of the display device 30.

FIG. 4 shows a calendar view screen 200 of the activity or health tracking app, which is shown using the display screen 34 of the display device 30. The calendar view screen 200 provides an overview of health data for a plurality of time periods, such as a plurality of days, weeks, or months. The calendar view screen 200 includes a plurality of icons 202. Each icon 202 is displayed in association a time period of the plurality of time periods. For example, in the embodiment shown, the calendar view screen 200 provides an overview of health data for each of a plurality of days extending over several weeks and displays the plurality of icons 202 in association with the plurality of days. More particularly, in the embodiment shown, the calendar view screen 200 shows thirty-three icons 202 in association with thirty-three days extending over five weeks (i.e. the thirty-one days of March 2016, as well as the two days in the last week of February 2016). In the embodiment shown, the calendar view screen 200 includes day labels 204 (e.g. “1”, “2”, “3”. etc.) and a month label 206 (e.g. “March”), which identify which day each icon 202 is associated with. Additionally, the calendar view screen 200 includes a date range label 208 (e.g. “Feb. 28, 2016-Mar. 31, 2016”) that identifies the range of days that are displayed. Further embodiments may include different types of labels depending on the time periods being displayed.

Additionally, in the embodiment shown, the icons 202 are displayed in calendar arrangements for the respective months corresponding to the days associated with the icons 202. Particularly, as shown, the calendar view screen 200 includes a calendar arrangement 210 for the icons 202 associated with days of March 2016 and a partial calendar arrangement 212 for the icons 202 associated with days of February 2016. As used herein, the term “calendar arrangement” refers to an arrangement of icons, symbols, boxes, or the like, into rows and columns, wherein each row corresponds to a particular week of a month and each column corresponds to a day of the week (i.e. Sunday, Monday, etc.). The weeks (i.e. the rows) may be arranged chronologically from top to bottom. The days of the week (i.e. the columns) may be arranged chronologically from left to right. In some embodiments, the first week and/or the last week of the calendar arrangement omits the icons, symbols, boxes, or the like, which are associated with the end of the previous month and/or the beginning of the next month. For example, the icons 202 associated with Sunday Feb. 28, 2016 and Monday Feb. 29, 2016, are omitted from the calendar arrangement 210 for March 2016; instead they are included in a separate row in the calendar arrangement 212 for February 2016. In other embodiments, the first week and/or last week of the month in the calendar arrangement includes days from other months (e.g. February 28 and 29 could be shown in the same row as March 1-5). In the embodiment shown, the days of the week of the calendar arrangements 210, 212 are arranged, from left to right, as Sunday through Saturday, but other arrangements are possible, such as Monday through Sunday, and so forth.

Each of the icons 202 is shaped, sized, and/or colored in various ways to indicate progress or status of various health metrics for the time period (e.g. the day) associated with the respective icon. Particularly, various attributes of an icon 202 are modulated depending on values of one or more health metrics corresponding to the time period associated with the respective icon. In some embodiments, each of the icons 202 is designed to simultaneously indicate a progress or status of multiple health metrics for the associated period of time.

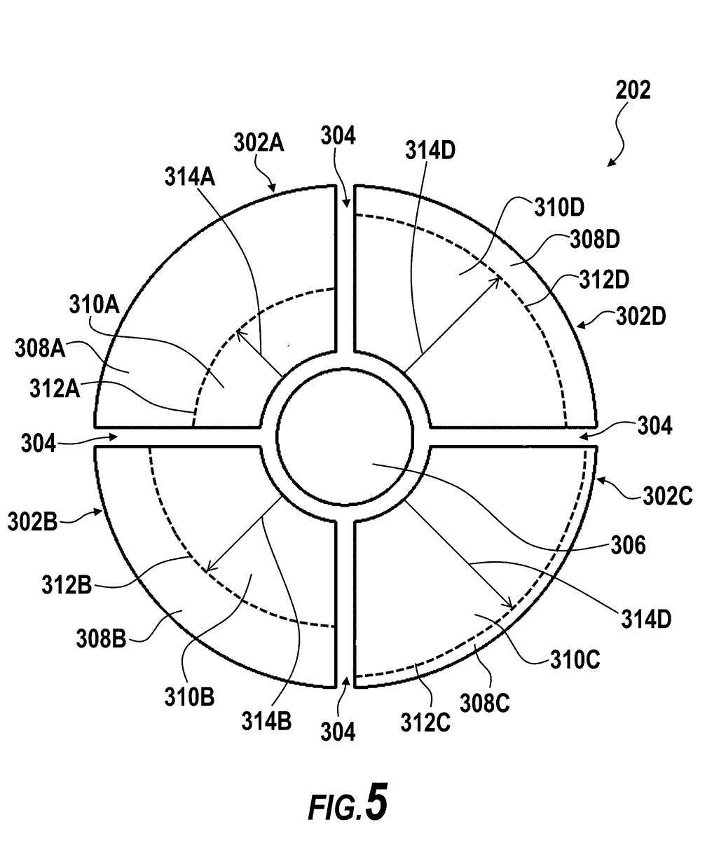

With reference to FIG. 5, an exemplary icon 202 is shown in greater detail. As can be seen, the icon 202 is very similar to the chart 102 of FIG. 3, which advantageously provides a familiar experience to the user across both the dashboard screen 100 and calendar view screen 200 the of activity or health tracking app. However, the icon 202 is merely exemplary and can take any form suitable for indicating a progress or status of at least one health metric. Much like the chart 102, the icon 202 is in in the form of a wheel divided into a plurality of sectors 302, including sectors 302A-302D. The sectors 302 in the embodiment of FIG. 5 are circular sectors, each sector provided as a quadrant of the wheel. Each sector 302 is positioned between two adjacent sectors (e.g., sector 302B is positioned between adjacent sector 302A and 302C). Linear gaps 304 divide each of the adjacent sectors 302. A central hub 306 is provided at the center of the icon 202, and each of the linear gaps 304 extends radially away from the central hub 304.

In the embodiment shown, each sector 302 of the wheel is associated with a health metric for the user. In one embodiment, the health metrics associated with the sectors 302 reflect those which are associated with the sectors 104 of the chart 102, however they are not labeled in this embodiment to create a more streamlined look. Particularly, sector 302A is associated with steps for the day, sector 302B is associated with active minutes (e.g., time participating in fitness activities) as well as calories burned for the day, sector 302C is associated with sleep time for the day, and sector 302D is associated with calories consumed for the day. In at least one embodiment, each of the different sectors 302 is represented on the icon by a different color to further illustrate that each sector is associated with a different activity or health parameter (e.g., sector 302A may be a different color from each of sectors 302B, 302C and 302D). These colors may match the colors associated to the sectors 104 of the chart 102 discussed above.

At least one an attribute of each icon 202 is modulated to graphically illustrate progress toward a goal for at least one health metric. Particularly, in one embodiment, an attribute of each of sector 302 is modulated to indicate a progress towards a goal for the health metric associated with the respective sector 302. In the embodiment shown, progress towards a goal for each health metric is shown by modulating a fill level of each sector 302. However, a size, shape, or color of each sector 302 can be similarly modulated to indicate a progress towards a goal for the health metric associated with the respective sector 302. As used herein, the term “fill level” refers to percent or ratio of an icon or a portion of an icon which is colored or shaded in a particular way that is different from the rest of the icon or portion of the icon.

In the embodiment shown, each of the sectors 302A-D of the icon 202 is split into a first section 308A-D and a second section 310A-D. In each case, a boundary 312A-D exists between the respective first section 308 and the respective second section 310. The first section 308 has a first color, and the second section 310 has a second color that is different from the first color. This boundary 312 may be provided by a defined line or may simply be represented by the color transition between the first section 308 and the second section 310. As a user makes progress towards a goal for the health metric associated with a respective sector 302, the respective boundary 312 moves away from the central hub 306 in a respective direction 314A-D. In other words, as a user makes progress towards a goal for the health metric associated with a respective sector 302, the respective second section 310 grows outward from the central hub 306 and, thus, comprises a larger percentage of the respective sector 302. Hence, the fill level of the respective sector 302 is increases as the user makes progress towards a goal for the health metric associated with a respective sector 302.

In the example shown, the sector 302A has a fill level of roughly 35%, indicating that the user has made 35% progress toward the goal for the health metric associated with the sector 302A (e.g. steps for the day). Similarly, the sector 302B has a fill level of roughly 70%, indicating that the user has made 70% progress toward the goal for the health metric associated with the sector 302B (e.g. active minutes or extra calories burned for the day). Similarly, the sector 302C has a fill level of roughly 90%, indicating that the user has made 90% progress toward the goal for the health metric associated with the sector 302C (e.g. sleep time for the day). Final, the sector 302D has a fill level of roughly 80%, indicating that the user has made 80% progress toward the goal for the health metric associated with the sector 302D (e.g. calories consumed for the day).

In some embodiments, the first section 308 and the second section 310 of at least one sector 302 are different shades of the same hue. Particularly, in one embodiment, the first section 308 is colored with a lighter shade of a particular hue and the corresponding second section 310 is colored with a darker shade of the particular hue. For example, in one embodiment, the first section 308A of the sector 302A is displayed with a lighter red color and the section 310A of the sector 302A is displayed with a darker red color. Similarly, the first section 308B of the sector 302B is displayed with a lighter orange color and the section 310B of the sector 302B is displayed with a darker orange color. Similarly, the first section 308C of the sector 302C is displayed with a lighter blue color and the section 310C of the sector 302C is displayed with a darker blue color. Finally, the first section 308D of the sector 302D is displayed with a lighter green color and the section 310D of the sector 302D is displayed with a darker green color. As used in herein, the term “lightness,” also known as “value,” refers to the relative degree to which black or white is mixed with a given hue. Accordingly, a “lighter” shade of a particular hue is closer to white and a “darker” shade of a particular hue is closer to black. Additionally, as used herein, the term “hue” refers to the quality of a color that is defined by the wavelength of light being produced or reflected, whereas the term “color” as used herein refers to a particular combination of hue, color saturation, lightness (value), brightness, temperature, etc. For example, as used herein, light red color and a dark red color are the same hue but a different color.

In some embodiments, in addition to modulating an attribute of each of the individual sectors 302, at least one attribute of the entire icon 202 modulated to indicate a status of an additional health metric for the day associated with the respective icon 202. Particularly, in some embodiments, a color saturation of the entire icon 202 is modulated to indicate the status of an additional health metric. In one embodiment, the color saturation of each icon 202 is modulated to indicate a value of a health perception metric for the day associated with each respective icon 202. As used herein, the term “color saturation,” also known as “chroma” or “intensity,” refers to the extent to which grey is mixed with a given hue or, in other words, the intensity or purity of a given hue. Accordingly, a “desaturated” hue appears dull and closer to grey, whereas “saturated” hue appears vivid and further from grey.

Referring back to FIG. 4, icons 202 associated with days in which the user provided a relatively low health perception score are displayed with relatively low color saturation. Conversely, icons 202 associated with days in which the user provided relatively high health perception score are displayed with relatively high color saturation. In some embodiments, icons 202 associated with days in which the user did not provided any health perception score are displayed with low color saturation and with high lightness, or in other words, are displayed with a desaturated light grey appearance. In one embodiment, icons 202 associated with days in which the user provided a minimum health perception score (e.g. “0”) are displayed with 0% high color saturation and icons 202 associated with days in which the user provided a maximum health perception score (e.g. “10”) are displayed with 100% high color saturation. Similarly, icons 202 associated with days in which the user provided a health perception score somewhere between the minimum and the maximum (e.g. “1” through “9”) are displayed with corresponding partial color saturation (e.g. 10% though 90%).

In some embodiments, the calendar view screen 200 further includes a summary of at least one of the health metrics associated with the icons 202. Particularly, in at least one embodiment, the calendar view screen 200 includes a health perception summary 214. In the embodiment shown, the health perception summary 214 includes a summary 216 of how many days (e.g. “6 DAYS”) are shown in which the user provided a low health perception score (e.g. a score between “1” and “6”). Similarly, the health perception summary 214 includes a summary 218 of how many days (e.g. “23 DAYS”) are shown in which the user provided a high health perception score (e.g. a score between “7” and “10”). The range of health perception scores that are considered “high” may correspond to a goal range for the health perception metric. The summaries 216 and 218 may include reference icons that are similar to the icons 202, which have color saturation that corresponds to the ranges for low and high health perception scores. The health perception summary 214 further includes a summary 220 of a number of days out of the total number of days shown in which the user provided a health perception score (e.g. “29 OF 33 DAYS LOGGED”). Finally, the health perception summary 214 includes a summary 222 of how many days are shown in which the user provided a high health perception score and also achieved his or her goals with respect to each of other the health metrics associated with the sectors 302 of the icons 202. The summary 222 may also include a gold colored reference icon that is similar to the icons 202 but with each of the sectors having 100% fill level to represent all goals being achieved.

In another embodiment, a permanent copy of the programming instructions for individual ones of the aforementioned applications (e.g. the activity or health tracking app including the dashboard screen 100 and/or the calendar view screen 200) may be placed into permanent storage devices (such as e.g., memory 38 of the display device and/or memory 28 of the health monitoring device 20) during manufacture thereof, or in the field, through e.g., a distribution medium (not shown), such as a compact disc (CD), or through a communication interface, such as the transceiver 39 of the display device 30 and/or the transceiver 29 of the health monitoring device 20 (from a distribution server, or the like). That is, one or more distribution media having an implementation of the agent program may be employed to distribute the agent and program various computing devices.

### Method of Presenting Health Data

Methods for operating the health tracking system 10 are described below. In particular, a method of presenting health data to a user is provided. In the description of the methods, statements that a method is performing some task or function refers to a controller or general purpose processor executing programmed instructions stored in non-transitory computer readable storage media operatively connected to the controller or processor to manipulate data or to operate one or more components in the health tracking system 10 to perform the task or function. Particularly, the processor 37 of the display device 30 and/or the processor 27 of the health monitoring device 20 above may be such a controller or processor. Alternatively, the controller or processor may be implemented with more than one processor and associated circuitry and components, each of which is configured to form one or more tasks or functions described herein. Additionally, the steps of the methods may be performed in any feasible chronological order, regardless of the order shown in the figures or the order in which the steps are described.

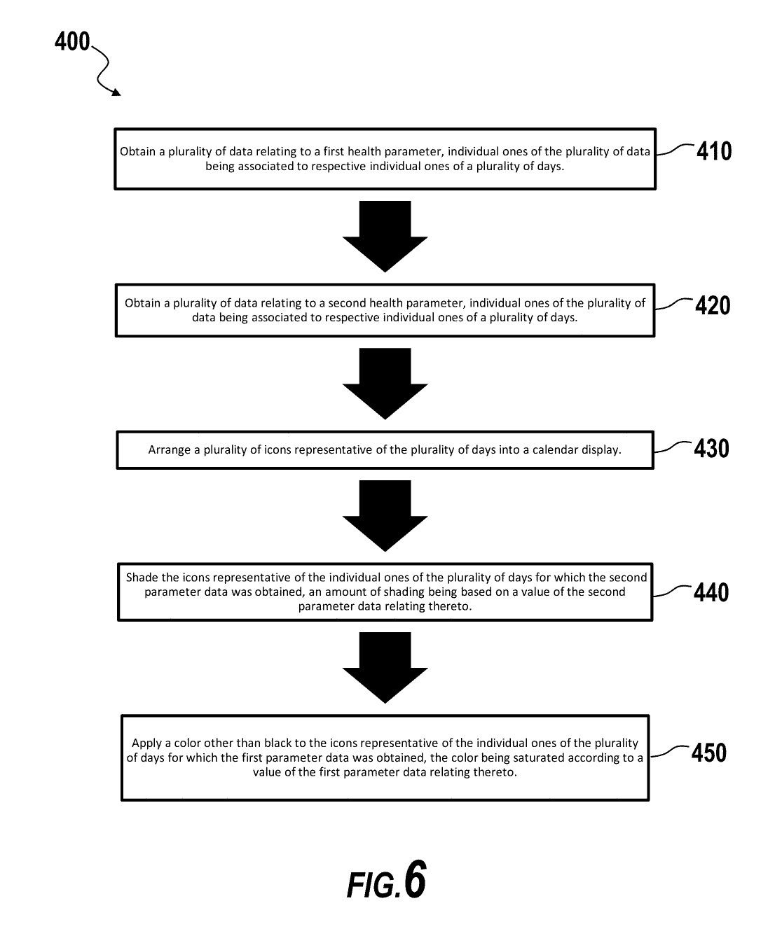

With reference now to FIG. 6, an exemplary embodiment of a method 400 for presenting health data to a user is shown. The method begins with a step of obtaining a plurality of data relating to a first health parameter, individual ones of the plurality of data being associated to respective individual ones of a plurality of days (block 410) and with a step of obtaining a plurality of data relating to a second health parameter, individual ones of the plurality of data being associated to respective individual ones of a plurality of days (block 420). Particularly, with respect to the embodiments disclosed in detail herein, the processor 37 of the display device 30 is configured to receive health data. As discussed above, health data may comprise any data relating to a user's health and general wellbeing, such as activity data, nutritional data, physiological data, and health perception data. Additionally, the health data may be received in a raw measured form or in a processed form. In some embodiments, health data has previously been stored in the memory 38, and the processor 37 is configured to receive at least some of the health data by reading it from the memory 38. In some embodiments, the processor 37 is configured to receive at least some of the health data from an external device, such as the health monitoring device 20 or a remote server, via the transceiver 39.

Additionally, in some embodiments, the processor 37 is configured to receive at least some of the health data as user inputs, such as touch inputs to the display screen 34 or inputs to some other user interface, via the input/output interface 36. Particularly, in one embodiment, the method 400 further includes a step of providing a health perception prompt on the display device. In such embodiments, the processor 37 is configured to operate the display screen 34 to display a health perception prompt, such the health perception prompt 140 described above. The user may provide health perception data via the health perception prompt, for example by providing health perception scores using the slider 142 of the health perception prompt 140. The processor 37 is configured to receive the health perception data provided by the user via the health perception prompt.

In many embodiments, the processor 37 of the display device 30 is configured to process the received health data to prepare it for presentation on the display screen 34 of the display device 30 as at least a first health metric and a second health metric. As discussed above, a health metric may comprise any standard of measurement relevant to an assessment of the health and general wellbeing of a user. In some embodiments, the processor 37 is configured to substantially process raw measured health data to provide the first and second health metrics. However, in other embodiments, the processor 37 is configured to simply organize or otherwise prepare the health data into a form that is presentable via the display device 30.

Each health metric includes a plurality of values, each of which is associated with a one of a plurality of time periods. As described herein, the plurality of time periods generally comprises a plurality of days, but could also comprise a plurality of hours, a plurality of weeks, a plurality of months, a plurality of years, or any other useful increment of time. In one embodiment, the processor 37 is configured to process the health data to determine values for each health metric for each of the plurality of time periods. For example, in one particular embodiment, the processor 37 is configured to process the health data to provide five different health metrics: steps for the day, active minutes for the day, sleep time for the day, calories consumed for the day, and a health perception score for the day. In one embodiment, the processor 37 determines daily values for each of the health metrics based on the health data.

The method 400 continues with a step of arranging a plurality of icons representative of the plurality of days into a calendar display (block 430). Particularly, with respect to the embodiments disclosed in detail herein, the processor 37 of the display device 30 is configured to operate the display screen 34 to display a plurality of icons, such as the icons 202 of the calendar view screen 200 of FIG. 4. Each of the icons is displayed in association with a corresponding time period of the plurality of time periods, such as by the day and month labels 204, 206 of the calendar view screen 200 of FIG. 4. In at least one embodiment, the icons are displayed in association with a plurality of days of at least one month. In such an embodiment, the plurality of icons may be displayed in a calendar arrangement for the at least one month, such as the calendar arrangement 210 for the month of March 2016 described above.

The method 400 continues with a step of shading the icons representative of the individual ones of the plurality of days for which the second parameter data was obtained, an amount of shading being based on a value of the second parameter data relating thereto (block 440). In broader terms, the method step 440 comprises modulating a first attribute of each icon depending on the value of the first health metric associated with the time period corresponding to the respective icon. Particularly, with respect to the embodiments disclosed in detail herein, the processor 37 of the display device 30 is configured to modulate, vary, or adjust (via operation of the display screen 34) an attribute of the each of the icons dependent on the value of a health metric for the time period associated with the respective icon. In some embodiments, the processor 37 is further configured to modulate, vary, or adjust (via operation of the display screen 34) a further attributes of the each of the icons dependent on the values of further health metrics for the time period associated with the respective icon. In some embodiments, the attribute(s) of each icon is at least one of a shape, a size, a shading, and a fill level of each icon. In some embodiments, the attribute(s) of each icon is an attribute of only a portion of each icon, such as a fill level of one of the sectors 302A-D of the icon 202 shown in FIG. 5. As used herein, the term “shading” refers to modulating, varying, or adjusting a lightness or darkness (as defined above) of an icon or a portion of an icon. Shading is one of various ways in which an icon can be modulated or a fill level of an icon or a portion thereof can be indicated.

In one particular embodiment, the processor 37 is configured to modulate a fill level of each of the sectors 302A-D of each respective icon based on values for the health metric associated with the respective sectors 302A-D. Particularly, the processor 37 is configured to modulate a fill level of the sector 302A for each icon based on the values for the health metric associated with the sector 302A (e.g. steps for the day). Similarly, the processor 37 is configured to modulate a fill level of the sector 302B for each icon based on the values for the health metric associated with the sector 302B (e.g. active minutes for the day). Similarly, the processor 37 is configured to modulate a fill level of the sector 302C for each icon based on the values for the health metric associated with the sector 302C (e.g. sleep time for the day). Finally, the processor 37 is configured to modulate a fill level of the sector 302D for each icon based on the values for the health metric associated with the sector 302D (e.g. calories consumed for the day).

In at least one embodiment, the method 400 continues with a step of applying a color other than black to the icons representative of the individual ones of the plurality of days for which the first parameter data was obtained, the color being saturated according to a value of the first parameter data relating thereto (block 450). Particularly, with respect to the embodiments disclosed in detail herein, the processor 37 of the display device 30 is configured to modulate, vary, or adjust (via operation of the display screen 34) a color saturation of the each of the icons dependent on the value of a further health metric for the time period associated with the respective icon. In one embodiment, the processor 37 is configured to modulate, vary, or adjust a color saturation of the each of the icons dependent on the value of a health perception metric for the time period associated with the respective icon as discussed above.

In one particularly embodiment, the processor 37 is configured to operate the display screen 34 to display icons 202 associated with days in which the user provided a relatively low health perception score with relatively low color saturation. Conversely, the processor 37 is configured to operate the display screen 34 to display icons 202 associated with days in which the user provided relatively high health perception score with relatively high color saturation. In some embodiments, the processor 37 is configured to operate the display screen 34 to display icons 202 associated with days in which the user did not provided any health perception score with low color saturation and with high lightness, or in other words, with a desaturated light grey appearance.

The herein described applications (e.g., the activity or health tracking app including the dashboard screen 100 and/or the calendar view screen 200) improve the functioning of the display device 30 and/or the health monitoring device 20, respectively or in combination by enabling it/them to provide a health tracking device having a display that is configured to show a concise summary of numerous activity-related parameters for a given period of time, thereby allowing the user to identify trends and associations between health and activity in a quick and convenient manner.

The foregoing detailed description of one or more exemplary embodiments of the health tracking system has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed exemplary embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the exemplary embodiments contained herein.

It will be appreciated that the various ones of the foregoing aspects of the present disclosure, or any parts or functions thereof, may be implemented using hardware, software, firmware, tangible, and non-transitory computer readable or computer usable storage media having instructions stored thereon, or a combination thereof, and may be implemented in one or more computer systems.

What is claimed is:

1. A method of presenting health data to a user, the method comprising:
obtaining a plurality of data relating to a first health parameter, individual ones of the plurality of data being associated to respective individual ones of a plurality of days;
obtaining a plurality of data relating to a second health parameter, individual ones of the plurality of data being associated to respective individual ones of a plurality of days;
arranging a plurality of icons representative of the plurality of days into a calendar display;
applying a color other than black to the icons representative of the individual ones of the plurality of days for which the first parameter data was obtained, the color being saturated according to a value of the first parameter data relating thereto; and
shading the icons representative of the individual ones of the plurality of days for which the second parameter data was obtained, an amount of shading being based on a value of the second parameter data relating thereto.

2. The method of claim 1, wherein the second health parameter data comprises a subjective health perception input by the user.

3. The method of claim 2, further comprising providing a prompt on the display device configured to enable the user to input the subjective health perception therein.

4. The method of claim 1, wherein the first health parameter comprises one or more of: steps, calories consumed, calories burned, duration of exercise, and duration of sleep, and each is associated to a different one of the colors other than black applied to the individual ones of the plurality of days for which the first parameter data was obtained.

5. The method of claim 1, further comprising modulating the icon associated to the individual ones of the plurality of days for which the first parameter data was obtained based at least in part on the value of the first parameter data relating thereto.

6. The method of claim 5, wherein the act of modulating comprises one or more of: modulating a shape of the icon, modulating a size of the icon, and modulating a fill level of the icon.

7. The method of claim 1, wherein the act of arranging the plurality of icons representative of the plurality of days into the calendar display comprises arranging each icon to correspond to a day in a plurality of days of a month.

8. The method of claim 7, wherein the calendar display comprises at least six weeks, each week comprising seven ones of the plurality of icons, the seven icons representative of seven days of a week, the calendar display further comprising text indicating a date and/or day of the week which each of the plurality of icons represents.

9. The method of claim 1, wherein the plurality of icons comprise circles having at least four quadrants.

10. The method of claim 9, wherein the first heath parameter comprises at least four measurable parameters each being associated to a different color and being represented in a respective one of the four quadrants of the circle.

11. A display device for presenting health data to a user, the display device comprising:
one or more transceivers;
a storage apparatus; and
a processor configured to execute at least one computer application thereon, the computer application comprising a plurality of instructions stored at the storage apparatus and which are configured to, when executed, cause the display device to:
receive at the one or more transceivers measurable health parameter data collected via one or more sensors, the measurable health parameter data being associated to one of a plurality of 24 hour time periods;
receive at the one or more transceivers health perception data input by the user, the health perception data being associated to one of a plurality of 24 hour time periods;
display via a display screen a plurality of icons, the plurality of icons representative of the plurality of 24 hour time periods and arranged into a calendar configuration;
modulate at least one attribute of each icon based on a value of the measurable health parameter data for each of the respective 24 hour time periods; and
modulate a shading of each icon based on a value of the health perception data for each of the respective 24 hour time periods.

12. The display device of claim 11, wherein the wherein the plurality of instructions are further configured to, when executed by the processor, cause the display device to: cause a display screen to display a health perception prompt thereon, the health perception data being received via the health perception prompt.

13. The display device of claim 11, wherein the measurable health parameter data comprises at least one of: steps, calories consumed, calories burned, duration of exercise, and duration of sleep.

14. The display device of claim 11, wherein the first attribute of each icon comprises at least one of a shape, a size, and a fill level of each icon, the modulation thereof comprising one or more of: modulating the shape of the icon, modulating the size of the icon, and modulating a fill level of the icon.

15. The display device of claim 11, wherein the plurality of 24 hour time periods comprise individual days of a month, the calendar configuration comprising at least four weeks wherein each of the plurality of icons is displayed in association with a corresponding day of at least the four weeks, the calendar configuration further comprising text indicating a date and/or day of the week which each of the plurality of icons represents.

16. The display device of claim 11, wherein the plurality of icons each comprises a circle having at least four quadrants, the measurable health parameter data comprises at least four measurable parameters each being associated to a different non-black colors and being represented via filling in a respective one of the four quadrants of the circle.

17. A non-transient computer readable medium comprising instructions for controlling a display device to present health data to a user, the instructions configured to cause the display device to:
receive a plurality of health data, individual ones of the plurality of data being associated to respective individual ones of a plurality of days, the health data comprising first subjective data and second measurable data;
process the plurality of health data for presentation on a display device, the processing comprising determining a value for each of the subjective and the measurable data for individual ones of the plurality of days;
display a plurality of icons in a calendar arrangement such that each icon corresponds to an individual one of a plurality of days of the month and the icons are arranged to form at least six rows of seven icons;
modulate a first attribute of each icon based on the value of the subjective health data associated with the day corresponding to the respective icon; and
modulate a second attribute of each icon based on the value of the measurable health data associated with the day corresponding to the respective icon.

18. The computer readable medium of claim 17, wherein the first attribute of each icon is at least one of a shape, a size, and a fill level of each icon and the second attribute is a color saturation of each icon.

19. The computer readable medium of claim 17, wherein the plurality of icons each comprises a circle having at least four quadrants, the measurable health data comprises at least four measurable parameters each being associated to a different non-black colors and being represented via filling in a respective one of the four quadrants of the circle.

20. The computer readable medium of claim 19, wherein the second attribute comprises a shading applied to the entirety of all four quadrants of colors of an icon.
